(19) United States
(12) Patent Application Publication
(10) Pub. No.: US 2019/0237036 A1
(43) Pub. Date: Aug. 1, 2019

(54) DISPLAY DEVICE

(71) Applicant: Japan Display Inc., Tokyo (JP)

(72) Inventor: Hiroshi KURIHARA, Tokyo (JP)

(21) Appl. No.: 16/256,677

(22) Filed: Jan. 24, 2019

(30) Foreign Application Priority Data
Jan. 26, 2018 (JP) 2018-011461

(51) Int. Cl. G09G 3/36; G02F 1/1362; G02F 1/1368

(52) U.S. Cl. CPC G09G 3/3677; G02F 1/136286; G02F 1/1368; G09G 2330/02; G09G 2300/0426; G09G 2300/0819; G09G 2310/08; G09G 2300/0814

(57) ABSTRACT

An object of the invention is to provide a display device capable of detecting abnormality or failure of gate lines and a gate line driving circuit. The display device has a display area and a peripheral area surrounding the display area. The display device includes plurality of gate lines extending in a first direction in the display area and connected to plurality of TFTs, a gate line driving circuit provided in the peripheral area and connected with one ends of the gate lines, an OR circuit provided in the peripheral area and having inputs connected with the other ends of the gate lines, and a counter provided in the peripheral area and to which output of the OR circuit is connected.

### CLAIM OF PRIORITY

The present application claims priority from Japanese Patent Application JP 2018-11461 filed on Jan. 26, 2018, the content of which is hereby incorporated by reference into this application.

### BACKGROUND

The present invention relates to a display device and, particularly, can be applied to a display device that is provided with a fault detection function.

Electronic parts intended to be used in automotive vehicles are required to comply with Automotive Safety Integrity Level (ASIL). Here, the ASIL is a safety level classified into four degrees A to D that must be fulfilled to avoid a variety of possible failures (hazards) that may occur in every electronic system that is mounted in an automotive vehicle. Liquid crystal display devices for use in automotive vehicles also need to be available as ASIL-compliant liquid crystal display devices or display modules.

Japanese Unexamined Patent Application Publication No. Hei 2-124530 discloses a technical approach in which pixels for monitoring which differ from pixels for display are arranged in an area outside the display region of a liquid crystal panel.

### SUMMARY

ASIL-compliant display devices or display modules need to have a capability of detecting a fault or failure at a circuit level in a display device.

An object of the present invention resides in providing a display device that is capable of detecting a fault or failure of a gate line or a gate line driving circuit

Other challenges/objects and novel features will become apparent from description herein and the accompanying drawings.

A representative aspect of the present invention is outlined as below.

A display device has a display area and a peripheral area surrounding the display area. The display device includes a plurality of gate lines extending in a first direction in the display area and connected to a plurality of TFTs, a gate line driving circuit provided in the peripheral area and connected with one ends of the gate lines, an OR circuit provided in the peripheral area and having inputs connected with the other ends of the gate lines, and a counter provided in the peripheral area and to which output of the OR circuit is connected.

### BRIEF DESCRIPTION OF THE DRAWINGS

FIG. 1 is a diagram depicting a general configuration of a display device pertaining to an embodiment of the invention;

FIG. 2 is a perspective diagram schematically depicting the display device DSP pertaining to an embodiment of the invention;

FIG. 3 is a diagram depicting an example of a configuration of a principal part of the display device DSP pertaining to an embodiment of the invention;

FIG. 4 is a diagram depicting another example of a configuration of the principal part of the display device DSP pertaining to an embodiment of the invention;

FIG. 5 is a timing diagram for explaining operation of the display device in FIG. 4 when operating normally;

FIG. 6 is a timing diagram for explaining operation of the display device in FIG. 4 when encountering abnormality;

FIG. 7A is a diagram schematically depicting a configuration of a display system including the display device;

FIG. 7B is a diagram for explaining operation of a host processor HOST in FIG. 7A;

FIG. 8 is a diagram for explaining a decision flow in the display system in FIG. 7A;

FIG. 9 is a diagram depicting yet another example of a configuration of the principal part of the display device pertaining to an embodiment of the invention;

FIG. 10 is a timing diagram for explaining operation of the display device in FIG. 9 when operating normally;

FIG. 11 is a timing diagram for explaining operation of the display device in FIG. 9 when encountering abnormality;

FIG. 12 is a diagram for explaining another example of a configuration of the display device pertaining to an embodiment of the invention;

FIG. 13 is a timing diagram for explaining operation of the display device in FIG. 12 when operating normally;

FIG. 14 is a timing diagram for explaining operation of the display device in FIG. 12 when encountering abnormality; and

FIG. 15 is a diagram for explaining yet another example of a configuration of the display device pertaining to an embodiment of the invention.

### DESCRIPTION OF THE PREFERRED EMBODIMENTS

A respective embodiment of the present invention will be described with reference to the drawings.

Now, disclosure herein is purely illustrative only and appropriate modifications or alterations thereto which keep consistent with the spirit of the invention and which will readily occur to those skilled in the art should reasonably be included in the scope of the present invention. In addition, for more clarity of explanation, in some drawings, the width, thickness, shape, etc. of a constituent part may be depicted to appear to be more schematic than its actual aspect; however, such a depiction is purely exemplary and should not confine interpretation of the present invention.

In addition, in the present specification and respective drawings, an element corresponding to that described previously with regard to a drawing which is previously referred to is assigned an identical reference designator and its detailed description is omitted, as appropriate.

In an embodiment of the invention described herein, a liquid crystal display device is disclosed as an example of a display device. This display device is intended for the device that is mounted in an automotive vehicle, but, it can also be used for a diversity of devices, such as, a smartphone, a tablet terminal, a cellular phone terminal, a personal computer, a TV receiver, and a game console. A principal configuration which is disclosed in an embodiment of the invention described herein is also applicable to a self-luminous type display device having organic electroluminescence display elements, micro LED (uLED) or the like, an electronic paper type display device having electrophoretic elements or the like, a display device to which Micro Electro Mechanical Systems (MEMS) are applied, or a display device to which electrochromism is applied.

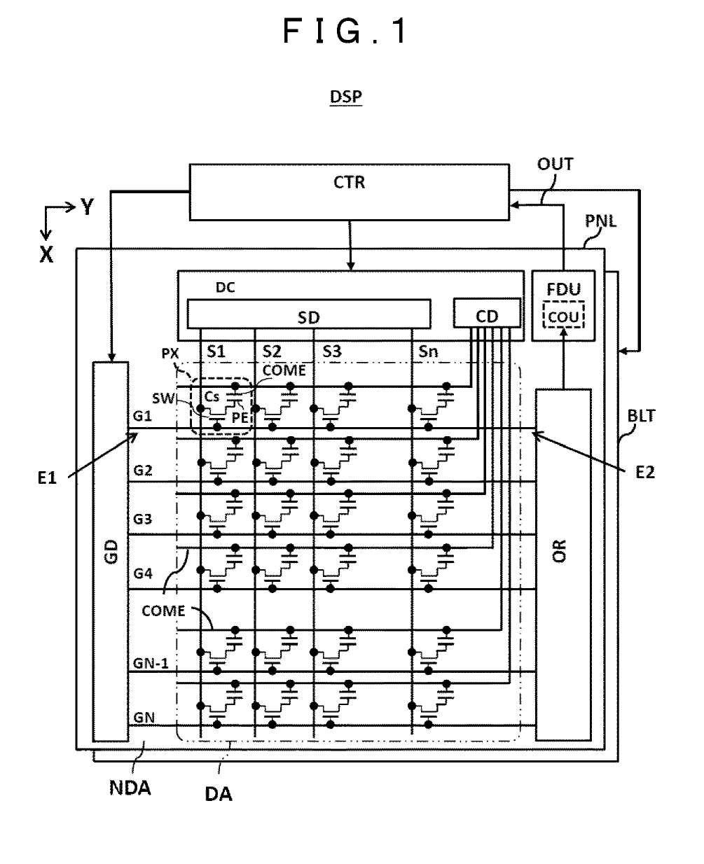

FIG. 1 is a diagram depicting a general configuration of a display device DSP according to an embodiment of the invention. Now, in the embodiment, the display device is a liquid crystal display device.

The display device DSP is provided with a display panel PNL and a back light BLT which illuminates the display panel PNL from its back side. Within the display panel PNL, there is provided a display area (display region) DA including display pixels PX arranged in a matrix.

As depicted in FIG. 1, the display area DA is provided with gate lines G (G1, G2, . . . , GN−1, GN) extending along rows in which a plurality of display pixels PX are arranged, source lines S (S1, S2, . . . , Sn) extending along columns in which the plurality of display pixels PX are arranged, and pixel switches SW, each of which is placed near a position where a gate line (scan line) G and a source line (signal line) S cross. Each of the plurality of display pixels PX has a pixel electrode PE and a common electrode COME and has a liquid crystal layer between the pixel electrode PE and the common electrode COME facing each other. Multiple common electrodes COME placed to extend in a direction (Y) of a plurality of rows are put in order in a column direction (X). Now, in an alternative configuration, a plurality of common electrodes COME placed to extend in the column direction (X) may be put in order in the row direction (Y).

A pixel switch SW is provided with a thin film transistor (TFT). A gate electrode of a pixel switch SW is electrically connected with an associated gate line G. A source electrode of a pixel switch SW is electrically connected with an associated source line S. A drain electrode of a pixel switch SW is electrically connected with an associated pixel electrode PE.

In addition, a gate driver (a gate line driving circuit) GD, a source driver (a source line driving circuit) SD, and a common electrode driving circuit CD are provided as drive means for driving the plurality of display pixels PX.

One end E1 of each of the plurality of gate lines G is electrically connected with an output part of the gate driver GD. The other end E2 of each of the plurality of gate lines G is electrically connected with one of a plurality of inputs of an OR circuit OR which will be described later, respectively. Now, in FIG. 1, one end E1 of a gate line G1 and the other end E2 of the gate line G1 are representatively depicted.

Each of the plurality of source lines S is electrically connected with an output part of the source driver SD. The common electrodes COME are electrically connected with an output part of the common electrode driving circuit CD. In FIG. 1, the source driver SD and the common electrode driving circuit CD are depicted such that they are provided within a drive circuit DC. The gate driver GD, the source driver SD, and the common electrode driving circuit CD are placed in a peripheral area (frame region) NDA surrounding the display area DA or on a flexible board connected to the display panel PNL. The gate driver GD applies a turn-on voltage to the plurality of gate lines G sequentially and supplies the turn-on voltage to the gate electrodes of the pixel switches SW electrically connected with a selected gate line G. In the pixel switches SW whose gate electrodes have been supplied with the turn-on voltage, this voltage creates a conducing path between the source and drain electrodes. The source driver SD supplies respective output signals onto each of the plurality of source lines S. The signals supplied onto the source lines are supplied to associated pixel electrodes PE via the pixel switches SW having the conducting channel between the source and drain electrodes.

Furthermore, the OR circuit OR and a detection unit (or a detection circuit) FDU are provided as detection means for detecting an abnormal state or trouble regarded as out of order, such as breaking of at least one of the plurality of gate lines G and failure or malfunction of the gate driver GD. The OR circuit OR is placed in the peripheral area NDA surrounding the display area DA. The detection unit FDU is placed in the peripheral area NDA surrounding the display area DA or on the flexible board connected to the display panel PNL. Each of a plurality of inputs of the OR circuit OR is electrically connected with the other end E2 of each of the plurality of gate lines G. That is, in this example, the gate driver GD and the OR circuit OR are placed in positions opposite to each other across the display area DA. Output of the OR circuit OR is electrically connected to input of a counter circuit COU provided within the detection unit FDU. The OR circuit OR conveys a transition or change from a turn-on voltage to a turn-off voltage of the plurality of gate lines G or a transition or change from the turn-off voltage to the turn-on voltage to the input of the counter circuit COU. The counter circuit COU counts the number of times the transition or change has occurred. The detection unit FDU monitors whether or not the number of times counted by the counter circuit COU matches the number of the plurality of gate lines G. If the number of times counted matches the number of the plurality of gate lines G, the detection unit FDU determines it as normal. Otherwise, if the number of times counted does not match the number of the plurality of gate lines G, the detection unit FDU determines it as abnormal. Once having determined it as abnormal, the detection unit FDU outputs an output signal OUT indicating that it has detected abnormality to a control circuit CTR.

The gate driver GD, the source driver SD, and the common electrode driving circuit CD are controlled in their operation by the control circuit CTR placed outside or inside the display panel PNL. Also, the control circuit CTR controls operation of the back light BLT. The control circuit CTR also controls operation of the display device DSP according to an output signal OUT from the detection unit FDU.

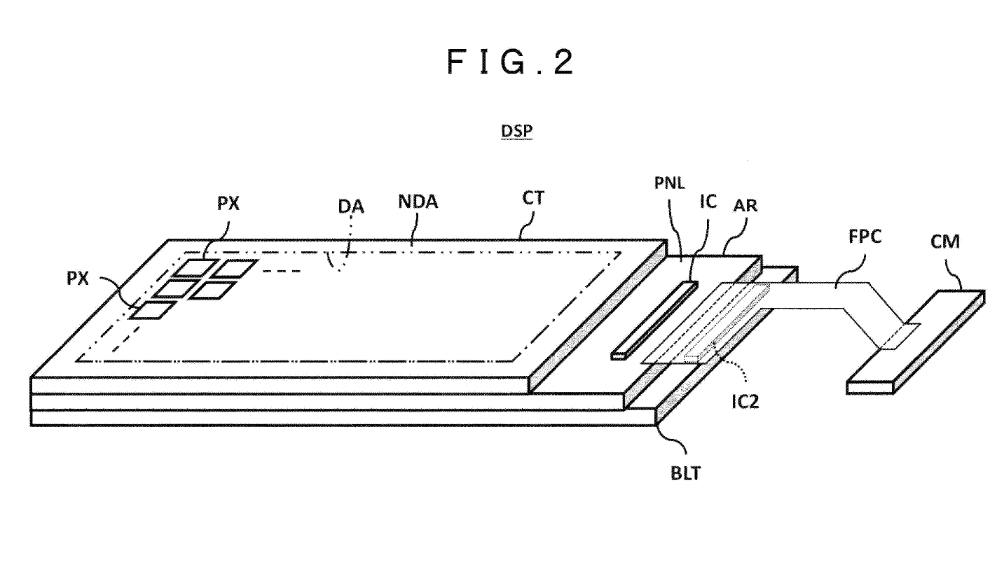

FIG. 2 is a perspective diagram schematically depicting the display device DSP pertaining to an embodiment of the invention.

The display device DSP includes, inter alia, an active matrix type liquid crystal display panel PNL, a back light BLT, a drive IC chip IC which drives the liquid crystal display panel PNL, a control module CM, and a flexible wiring board FPC. The liquid crystal display panel PNL includes an array substrate (a first substrate) AR and a counter substrate (a second substrate) CT placed facing the array substrate AR. The liquid crystal display panel PNL includes the display area DA in which an image is displayed and a frame-like non-display area (peripheral area) NDA surrounding the display area DA. The liquid crystal display panel PNL includes the plurality of display pixels (or unit display pixels) PX arranged in a matrix in the display area DA. The drive IC chip IC is mounted on the array substrate AR. The flexible wiring board FPC connects the liquid crystal display panel PNL and the control module CM. The control module CM is connected with the back light BLT by another flexible wiring board (not depicted).

The drive IC chip IC may be mounted on the flexible wiring board FPC as IC2, as drawn with dotted lines. The drive IC chip IC can be regarded as a display driver IC and the control module CM can be regarded as a timing controller TCON. The control circuit CTR in FIG. 1 can be regarded as the display driver IC and the timing controller TCON. The detection unit FDU in FIG. 1 can be provided within the drive IC chip IC or within the control module CM. Furthermore, with the control module CM being assumed as a host, the timing controller TCON and the control circuit CTR in FIG. 1 can be incorporated in the display driver IC. Additionally, with the control module CM assumed as a host, at least either of the timing controller TCON and the control circuit CTR in FIG. 1 can be provided as a separate component from the display driver IC.

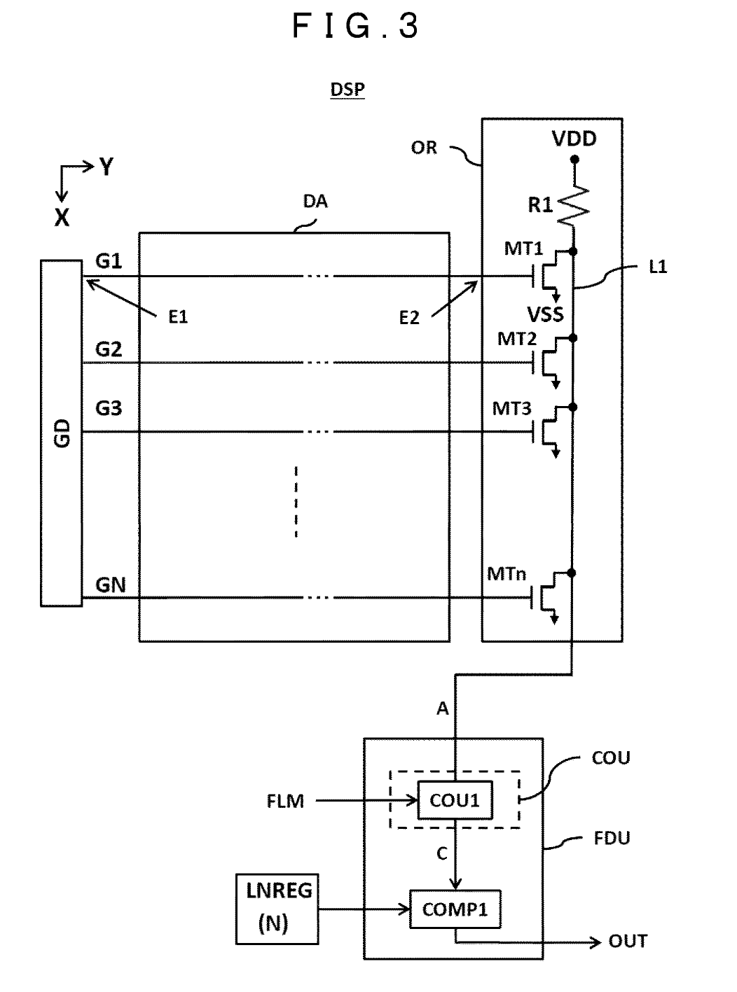

FIG. 3 is a diagram depicting an example of a configuration of a principal part of the display device DSP pertaining to an embodiment of the invention. Now, inter alia, the plurality of display pixels PX, the plurality of source lines, and the source driver SD are not depicted in FIG. 3 for simplifying the drawing.

One end E1 of each of the plurality of gate lines G (G1, G2, G3, . . . , GN) is electrically connected with the output part of the gate driver GD, as described with FIG. 1. The other end of each of the plurality of gate lines G (G1, G2, G3, . . . , GN) is electrically connected with one of the plurality of inputs of the OR circuit OR, respectively. Now, in FIG. 3 and other drawings, even in a case where a circuit logic is NOR, it is represented as the OR circuit in a broad sense. Although one end E1 of a gate line G1 and the other end E2 of the gate line G1 are only depicted representatively in FIG. 3, other gate lines G2 to GN likewise have one end E1 and the other end E2.

The OR circuit OR includes a plurality of N-channel type MOS transistors MT1 to MTn and each of a plurality of gate electrodes of the plurality of N-channel type MOS transistors MT1 to MTn is electrically connected to an associated one of the gate lines (G1 to GN), respectively. The plurality of gate electrodes of the plurality of N-channel type MOS transistors MT1 to MTn can be regarded as the inputs of the OR circuit OR. Drains of the plurality of N-channel type MOS transistors MT1 to MTn are electrically connected to a line L1. The line L1 is electrically connected to a first reference potential VDD which is a power supply potential via a resistor element R1. Each of sources of the N-channel type MOS transistors MT1 to MTn is electrically connected to a second reference potential VSS which is a ground potential. That is, the plurality of N-channel type MOS transistors MT1 to MTn configure an open drain type wired OR circuit. The line L1 is regarded as the output A of the OR circuit OR and the output A of the OR circuit OR is electrically connected to the input of a first counter circuit COU1.

When the plurality of gate lines G (G1, G2, G3, . . . , GN) are scanned sequentially, one of the gate lines G transitions from an unselected level like a low level to a selected level like a high level and, subsequently, transitions from the selected level to the unselected level. For example, a case, where a gate line G1 is scanned, is explained as follows. When the gate line G1 transitions from the unselected level like a low level to the selected level like a high level, an N-channel type MOS transistor MT1 electrically connected to the gate line G1 turns on and, therefore, the potential of the line L1 changes from a high level such as VDD to a low level such as VSS. Hence, the output A of the OR circuit OR turns to the low level. Then, when the gate line G1 transitions from the selected level to the unselected level, the N-channel type MOS transistor MT1 electrically connected to the gate line G1 turns off and, therefore, the potential of the line L1 changes from low level such as VSS to the high level such as VDD. Hence, the output A of the OR circuit OR turns to the high level. That is, in a normal state that is free of breaking of the plurality of gate lines G and failure or malfunction of the gate driver GD, the output A of the OR circuit OR changes between low and high levels accordingly when one gate line is switched between selected and unselected levels. The number of times this change occurs corresponds to the number of gate lines that are scanned. On the other hand, in an abnormal state that is out of order, when trouble occurs, such as breaking of the plurality of gate lines G and failure or malfunction of the gate driver GD, one or more of the plurality of gate lines are not switched to the selected level. Consequently, the number of time that the output A of the OR circuit OR changes between low and high levels will be smaller than the number of the plurality of gate lines G. Now, to avoid that the potential of the line L1 electrically connected to the output of the wired OR circuit turns to the low level (L) continuously when the plurality of gate lines are driven sequentially, attention should be paid to the following: when one gate line is driven, keep the potential of all the remaining gate lines electrically connected to the OR circuit at the unselected level such as the low level; and, once the level of one gate line has transitioned from the unselected level to the selected level and from the selected level to the unselected level, make a level transition of a next gate line to be driven to the selected level.

The detection unit FDU includes a first counter circuit COU1 to which the output OR of the OR circuit OR and a frame sync signal FLM are input and a first comparator circuit COMP to which a count output C of the first counter circuit COU1 is input.

The count value C of the first counter circuit COU1 is reset to zero in response to a transition from low to high levels of the frame sync signal and the first counter circuit COU1 is to count the number of times that each of the plurality of gate lines G1 to GN has transitioned from turn-on voltage to turn-off voltage until the reset. That is, the first counter circuit COU1 is to count the number of times that each gate line has transitioned from the selected level (high level) to the unselected level (low level). Now, the first counter circuit COU1 may be adapted to count the number of times that each gate line has transitioned from the unselected level (low level) to the selected level (high level).

The first comparator circuit COMP1 is a monitoring circuit which compares the count value of the first counter circuit COU1 with the number N of the plurality of gate lines G1 to GN. The number (N) of the gate lines can be obtained, for example, by inputting a value (N) of display lines that has been set in a display line number register LNREG provided within the driver IC chip IC (display driver IC) to the first comparator circuit COMP1. The first comparator circuit COMP1 monitors whether or not the number of times (C) counted by the counter circuit COU1 matches the number (N) of the plurality of gate lines G. If the number of times (C) counted matches the number (N) of the plurality of gate lines G, the detection unit FDU determines it as normal. Otherwise, if the number of times (C) counted does not match the number (N) of the plurality of gate lines G, the detection unit FDU determines it as abnormal. Once having determined it as abnormal, the detection unit FDU outputs an output signal OUT indicating that it has detected abnormality.

For instance, supposing that the plurality of gate lines G1 to GN are 500 lines, each of the plurality of gate lines G1 to GN is once switched to the high level and, then, switched to the low level during a one frame display period. Therefore, when the plurality of gate lines G1 to GN are free of breaking and the gate driver GD free of failure, malfunction, or the like, the count value of the first counter circuit COU1 will be 500. The first comparator circuit COMP1 compares the count value (C=500) of the first counter circuit COU1 with the number (N=500) of the plurality of gate lines G. In this case, there is a match between both and, therefore, the detection unit FDU determines it as normal.

On the other hand, in the event of an abnormal state that is out of order, e.g., there is one or plural broken lines among the plurality of gate lines G1 to GN or failure or malfunction is present in the gate driver GD, the count value C of the first counter circuit COU1 will become a value smaller than 500 (<500). The first comparator circuit COMP1 compares the count value (C<500) with the number (N=500) of the plurality of gate lines G. In this case, there is a mismatch between both and, therefore, the detection unit FDU outputs an output signal OUT indicating that it has detected abnormality.

In this way, it is enabled to detect an abnormal state or trouble regarded as out of order, such as breaking of the plurality of gate lines G and failure or malfunction of the gate driver GD.

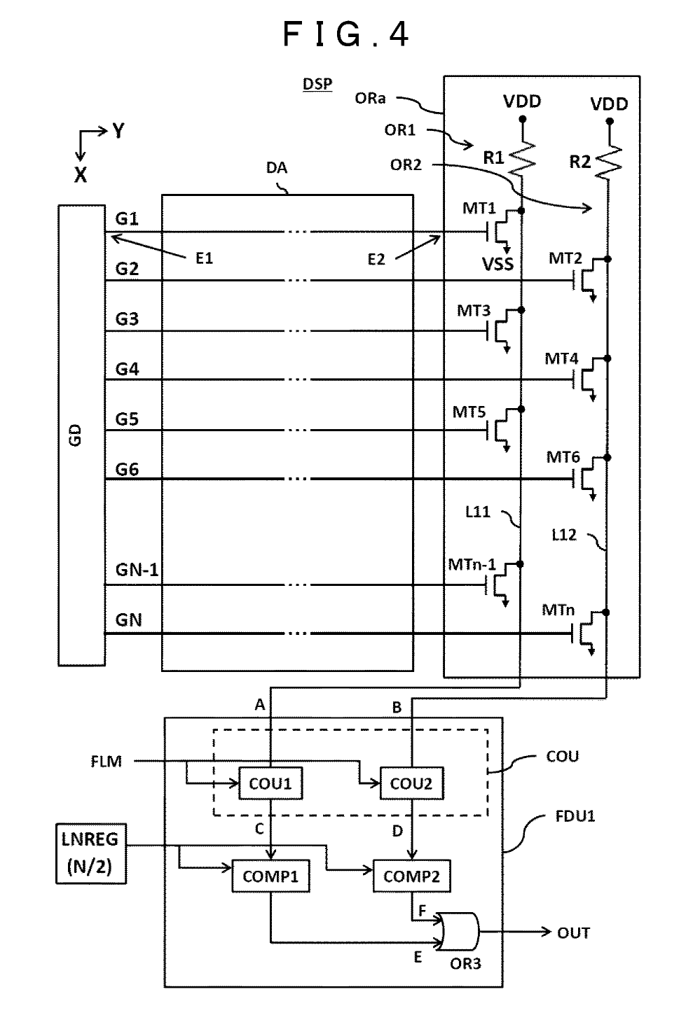

FIG. 4 is a diagram depicting another example of a configuration of the principal part of the display device DSP pertaining to an embodiment of the invention. In an OR circuit ORa depicted in FIG. 4, odd-number positioned gate lines G1, G3, G5, . . . , GN−1 of the plurality of gate lines (G1, G2, G3, . . . , GN) are electrically connected, respectively, to the gates of odd-number positioned N-channel type MOS transistors MT1, MT3, MT5 . . . , MTn−1 of the plurality of N-channel type MOS transistors MT1 to MTn. The drains of the odd-number positioned N-channel type MOS transistors MT1, MT3, MT5 . . . , MTn−1 are electrically connected to a line L11. The L11 is electrically connected to the power supply potential VDD via a resistor element R1 and forms an output A of a first wired OR circuit OR1 (or a first OR circuit OR1). Also, even-number positioned gate lines G2, G4, G6, . . . , GN) of the plurality of gate lines (G1, G2, G3, . . . , GN) are electrically connected, respectively, to the gates of even-number positioned N-channel type MOS transistors MT2, MT4, MT6 . . . , MTn of the plurality of N-channel type MOS transistors MT1 to MTn. The drains of the even-number positioned N-channel type MOS transistors MT2, MT4, MT6 . . . , MTn are electrically connected to a line L12. The line L12 is electrically connected to the power supply potential VDD via a resistor element R2 and forms an output B of a second wired OR circuit OR2 (or a second OR circuit OR2.

A detection unit (or a detection circuit) FDU1 includes a counter circuit COU and the output A of the first OR circuit OR1 and the output B of the second OR circuit OR2 are input to the counter circuit COU.

The counter circuit COU includes a first counter circuit COU1 to which the output A of the first OR circuit OR1 is input and a second counter circuit COU2 to which the output B of the second OR circuit OR2 is input. For the first counter circuit COU1 and the second counter circuit COU2, their count values C and D are reset to zero in response to a transition from high to low levels in response to a transition from low to high levels of the frame sync signal, as is the case for FIG. 3. The first counter circuit COU1 counts the number of times that each of the odd-number positioned gate lines G1, G3, G5, . . . , GN−1 has transitioned from turn-on voltage to turn-off voltage until the reset. The second counter circuit COU2 counts the number of times that each of the even-number positioned gate lines G2, G4, G6, . . . , GN has transitioned from turn-on voltage to turn-off voltage until the reset.

The detection unit FDU 1 also includes a first comparator circuit COMP1 to which the count value C of the first counter circuit COU1 is input and a second comparator circuit COMP2 to which the count value D of the second counter circuit COU2 is input.

The first comparator circuit COMP1 is a monitoring circuit which compares the count value C 00of the first counter circuit COU1 with a half (N/2) of the number (N) of the plurality of gate lines G (G1, G2, G3, . . . , GN). If the number of times C counted by the first counter circuit COU1 matches the half (N/2) of the number (N) of the gate lines G, the first comparator circuit COMP1 determines it as normal. Otherwise, if the number of times C counted does not match the half (N/2) of the number (N) of the plurality of gate lines G, the first comparator circuit COMP1 determines it as abnormal and outputs a comparison result E indicating abnormality.

The second comparator circuit COMP2 is a monitoring circuit which compares the count value D of the first counter circuit COU1 with a half (N/2) of the number (N) of the plurality of gate lines G (G1, G2, G3, . . . , GN). If the number of times D counted by the second counter circuit COU2 matches the half (N/2) of the number (N) of the gate lines G, the second comparator circuit COMP2 determines it as normal. Otherwise, if the number of times D counted does not match the half (N/2) of the number (N) of the plurality of gate lines G, the second comparator circuit COMP2 determines it as abnormal and outputs a comparison result F indicating abnormality.

For instance, supposing that the number of the gate lines G is 500 (N=500), the number of times C to be counted by the first counter circuit COU1 and the number of times D to be counted by the second counter circuit COU2 are 250 (C=250, D=250).

The detection unit FDU1 also includes a third OR circuit OR3 to which the comparison result E of the first comparator circuit COMP1 and the comparison result F of the second comparator circuit COMP2 are input. The third OR circuit OR3 outputs an output signal OUT indicating that it has detected abnormality according to the input of the comparison result E or the comparison result F.

The number of N-channel type MOS transistors electrically connected to the line 11 and the line 12 as depicted in FIG. 4 is smaller than the number of the N-channel type MOS transistors electrically connected to the line 1 as depicted in FIG. 3. Therefore, because the load capacity of the line L11 and the line L12 is smaller than that of the line L1, signal level transition speed on the line 11 and the line 12 is faster than that on the line L1, if all the N-channel type MOS transistors which are electrically connected to the line L1, line L11, and line L12 have an equal drive capability. Alternatively, if signal level transition speed on the line L1 is set equal to signal level transition speed on the line L11 and the line L12, the drive capability of each of the N-channel type MOS transistors electrically connected to the line L11 and line L12 can be smaller than that of each of the N-channel type MOS transistors electrically connected to the lines L1. Hence, because the size of each of the N-channel type MOS transistors electrically connected to the line L11 and line L12 can be shrunk, the layout area for each of the N-channel type MOS transistors can be reduced.

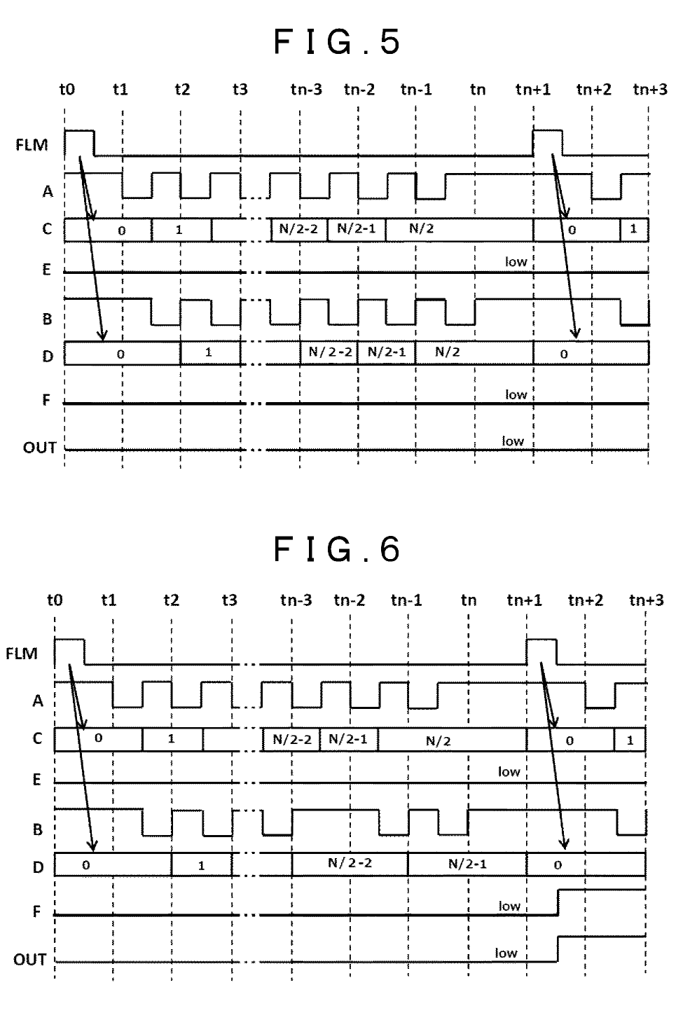

FIG. 5 is a timing diagram for explaining operation of the display device DSP in FIG. 4 when operating normally.

At time t0, the frame sync signal FLM turns to a high level and the count values C and D of first and second counters COU1 and COU2 are initialized to zero. After that, the frame sync signal FLM transitions from the high level to a low level.

At time t1, a gate line G1 turns from a low level to a high level and then, turns to a low level. Accordingly, the output A of the first OR circuit OR1 turns from a high pre-charged level to a low level at time t1 and then, turns to the high level. Therefore, the count value C of the first counter circuit COU1 becomes 1. Meanwhile, when the gate line G1 turns to the low level from a high level, a gate line G2 turns to a high level from a low level and an output B turns to a low level from a high level. And then the gate line G2 transitions from the high level to the low level at the time t2. Accordingly the output B of the second OR circuit OR2 turns from the low level to the high level at the time t2. Therefore, the count value D of the second counter circuit COU2 becomes 1.

For a time from time t2 to time tn, gate lines G3, G4, . . . , GN are sequentially scanned in the same manner as above, and the count value C of the first counter circuit COU1 becomes N/2 and the count value D the second counter circuit COU2 becomes N/2. At time tn, because both the count values C and D are N/2, the first and second comparator circuits COMP1 and COMP2 determine it as normal. Both comparison results E and F of the first and second comparator circuits COMP1 and COMP2 remain at a low level (low) and a detection result OUT of the third OR circuit OR3 also remains at a low level (low) which indicates normality.

At time tn+1, the frame sync signal FLM turns to a high level and the count values C and D of first and second counters COU1 and COU2 are initialized to zero. After that, the frame sync signal FLM transitions from the high level to a low level. Subsequently, the gate lines G1 and G2 are sequentially scanned in the same manner as above.

FIG. 6 is a timing diagram for explaining operation of the display device DSP in FIG. 4 when encountering abnormality. The difference between FIG. 6 and FIG. 5 lies in that the output B of the second OR circuit OR 2 remains at a low level for a time from time tn−3 to time tn−2 in FIG. 6. This means that a gate line which should be selected normally is not switched to a selected state such as a high level between a time tn−3 and a time tn−2. It is deduced that an abnormal state or trouble regarded as out of order is present, such as breaking of the gate lines G and failure or malfunction of the gate driver GD. Consequently, the count value D of the second counter circuit COU2 becomes a value that is smaller than N/2, such as N/2−1, at time tn. Accordingly, for a time from time tn+1 to time tn+2, the comparison result F of the second comparator circuit COMP2 transitions from low to high levels and the detection result OUT of the third OR circuit OR 3 also transitions from a low level to a high level, which indicates abnormality.

In this way, by the detection circuit FDU1, it is possible to detect an abnormal state or trouble regarded as out of order, such as breaking of the gate lines G and failure or malfunction of the gate driver GD.

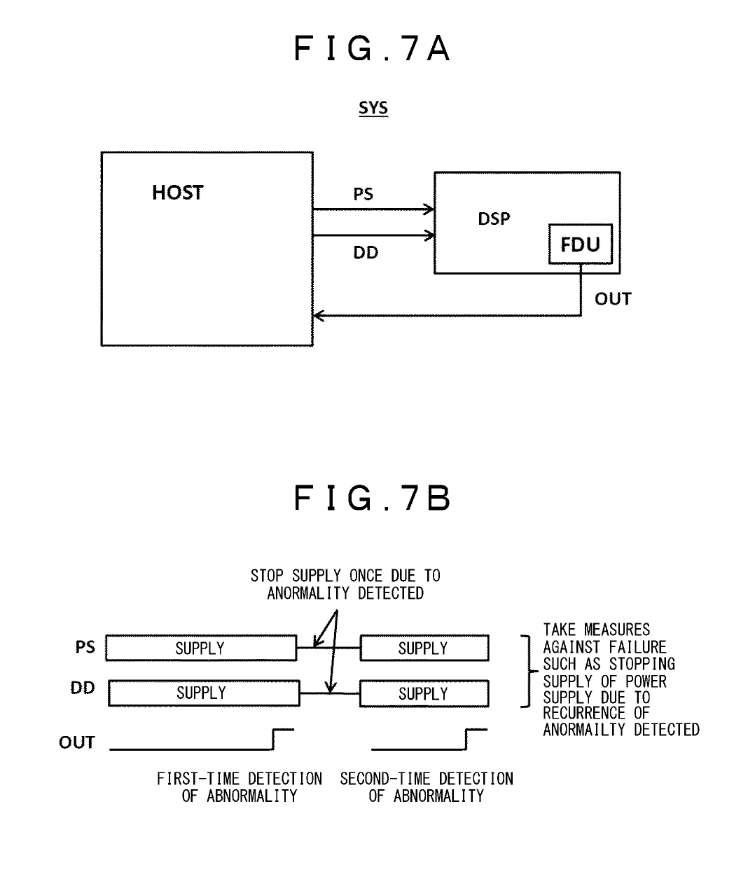

FIG. 7A is a diagram schematically depicting a configuration of a display system SYS including the display device DSP and FIG. 7B is a diagram for explaining operation of a host processor HOST.

As depicted in FIG. 7A, the display system SYS includes the host processor HOST and the display device DSP. The host processor HOST is capable of controlling the supply of a power supply PS such as the power supply potential VDD and VSS and the supply of display data DD. The display device DSP includes the detection unit FDU (or FUD1), as depicted in FIG. 1, FIG. 3, and FIG. 4. From the detection unit FDU (or FDU1), an output signal OUT indicating that the detection unit has detected abnormality is supplied to the host processor HOST.

When the host processor HOST, which has received the output signal OUT, receives a first-time detection of abnormality, the host processor HOST once interrupts and stops the supply of the power supply PS and display data DD to the display device DSP, as represented in FIG. 7B. After elapse of a predetermined interval of time, the host processor HOST restarts the supply of the power supply PS and display data DD. However, when receiving a second-time detection of abnormality, the host processor HOST determines that the abnormal state has recurred and takes measures against failure, such as interrupting and stopping the supply of the power supply PS and display data DD to the display device DSP.

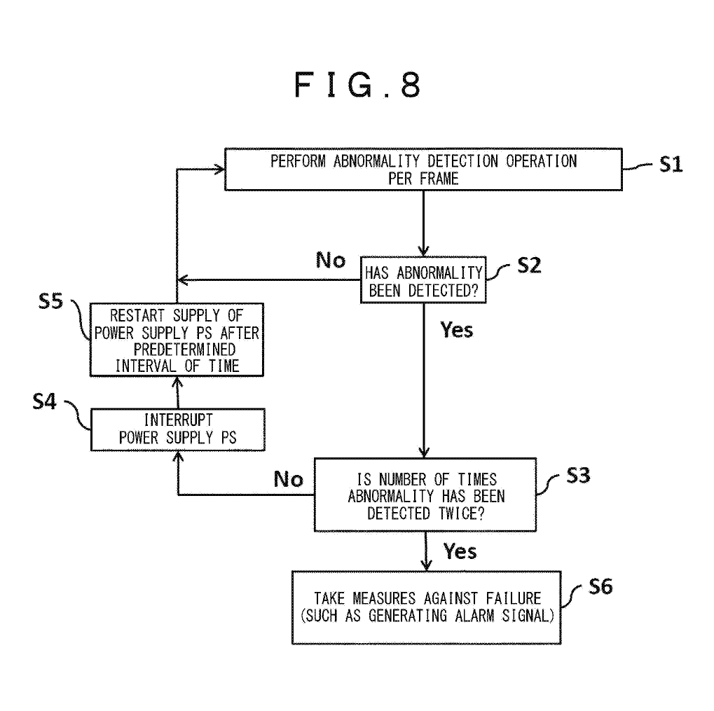

FIG. 8 is a diagram for explaining a determination flow in the display system in FIG. 7A. In FIG. 8, abnormality detection at a step S2 is whether or not the host processor HOST has received the output signal OUT indicating that the detection unit has detected abnormality from the detection unit FDU (or FDU1).

At step S1, the display device DSP performs an abnormality detection operation per frame.

At step S2, the display device DSP determines whether or not abnormality has been detected per frame. If no abnormality has been detected (No), a return is made to step S1 and the abnormality detection operation per frame is performed again. Otherwise, if abnormality has been detected (Yes), the host processor HOST determines whether or not the number of times that abnormality has been detected has reached a predetermined number of times (twice in the case of FIG. 7B and in this example). If the predetermined number of times has not been reached (No), a transition is made to step S4. If the predetermined number of times has been reached (Yes), a transition is made to step S6.

At step S4, the host processor HOST interrupts the supply of the power supply SP to the display device DSP and stops the supply of display data DD to the display device DSP and a transition is made to step S5.

At step S5, after elapse of a predetermined interval of time, the host processor HOST restarts the supply of the power supply PS to the display device DSP and restarts the supply of display data DD to the display device DSP. After that, a transition is made to step S1 and the abnormality detection operation per frame is performed in the display device DSP.

At step S6, because the number of times that abnormality has been detected has reached the predetermined number of time (twice), the host processor HOST determines that abnormality of the display device DSP has recurred and takes measures against failure. Taking the measures against failure is performing at least one processing task, such as generating an alarm signal, keeping interrupt of the power supply PS to the display device DSP, turning on a warning lamp provided in a display panel mounted in an automotive vehicle, or storing information on the failure into a nonvolatile memory provided inside an automotive vehicle.

Now, the predetermined number of time is not limited to twice and may be three times or four times. However, if the number of times is set too large, the measures against failure to cope with the occurrence of abnormality will be delayed; so, caution is needed.

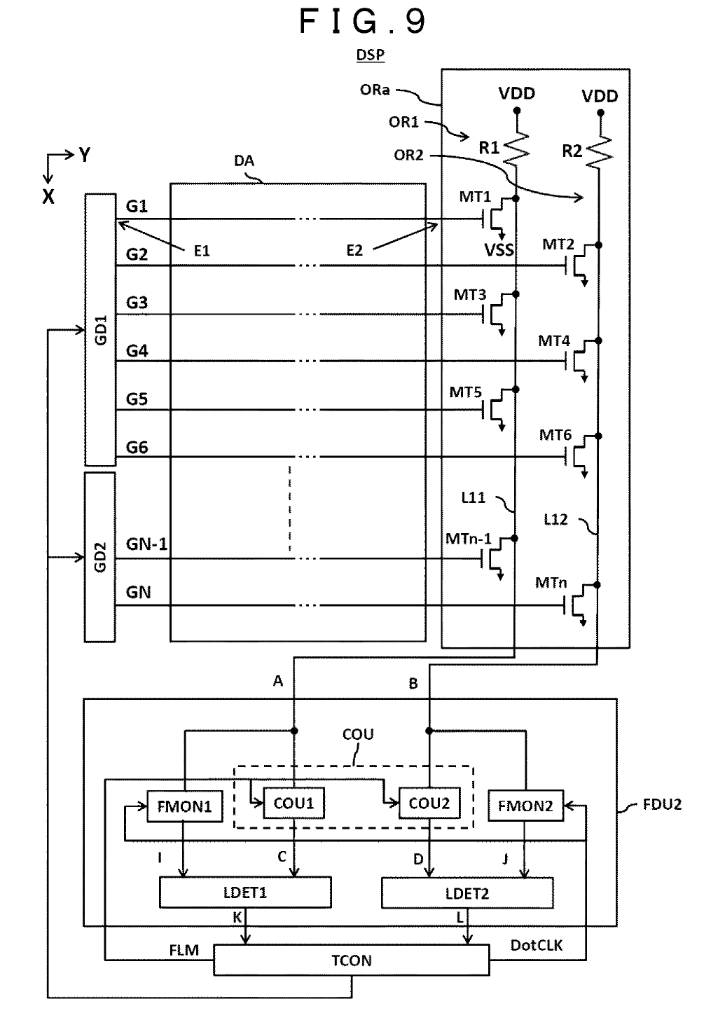

FIG. 9 is a diagram depicting yet another example of a configuration of the principal part of the display device DSP pertaining to an embodiment of the invention. The display device DSP which is depicted in FIG. 9 is an example of modification to the display device DSP depicted in FIG. 4 and the detection unit FDU1 is changed to a detection unit (or a detection circuit) FDU2 having a failure location determining function. Along with this change, the gate driver GD is changed to a first gate driver GD1 and a second gate driver GD2. Other components are the same as in FIG. 4.

The first gate driver GD1 is electrically connected to gate lines G1 to G6. The second gate driver GD1 is electrically connected to gate lines G7 to GN in this example. However, gate lines that are electrically connected to the first gate driver GD1 and the second gate driver GD2 are not limited those mentioned and can be altered.

The detection unit FDU2 has a failure location determining function. To enable implementation of this failure location determining function, frequency monitoring circuits FMON1 and FMON2 and location determining circuits LDET1 and LDET2 are provided. In this case, one or more comparator circuits, COMP1 and/or COMP2, need not be used.

The first and second frequency monitoring circuits FMON1 and FMON2 are, for example, adapted to receive a dot clock DotCLK which is supplied from the timing controller TCON.

The first frequency monitoring circuit FMON1 includes a counter circuit which counts the number of dot clocks DotCLK between one transition to low level and next transition to low level of the output A of the first OR circuit OR1 and monitors a cyclic period between transitions to low level of the output A. Similarly, the second frequency monitoring circuit FMON2 includes a counter circuit which counts the number of dot clocks DotCLK between one transition to low level and next transition to low level of the output B of the second OR circuit OR2 and monitors cyclic periods between transitions to low level of the output B. A detection result I of the first frequency monitoring circuit FMON1 and a detection result J of the second frequency monitoring circuit FMON2 indicate whether or not overflow OVF has occurred in the respective counter circuits of the first frequency monitoring circuit FMON1 and the second frequency monitoring circuit FMON2.

The first location determining circuit LDET1 has a function of locating an abnormal gate line according to the output C of the first counter circuit COU1 and the detection result I of the first frequency monitoring circuit FMON1. In response to input of the detection result I indicating occurrence of overflow OVF, the first location determining circuit LDET1 takes in the count value of the first counter circuit COU1 at that time as the output C of the first counter circuit COU1 and outputs the output C as a detection result K to the timing controller TCON. For example, the overflow OVF is detected when the counted value of the output C of the counter circuit COU1 is 1, the gate line G1 is determined to be malfunctioned. The location of a malfunction for other gate lines is detected in the same manner.

The second location determining circuit LDET2 has a function of locating an abnormal gate line according to the output D of the second counter circuit COU2 and the detection result J of the second frequency monitoring circuit FMON2.

In response to input of the detection result J indicating occurrence of overflow OVF, the second location determining circuit LDET2 takes in the count value of the second counter circuit COU2 at that time as the output D of the second counter circuit COU2 and outputs the output D as a detection result L to the timing controller TCON. For example, the overflow OVF is detected when the counted value of the output D of the counter circuit COU2 is 1, the gate line G2 is determined to be malfunctioned. The location of a malfunction for other gate lines is detected in the same manner.

According to the detection results K and L, the timing controller TCON controls operation of the first gate driver GD1 and the second gate driver GD2. That is, the timing controller TCON, when having been notified of abnormality in the gate line G1, stops a display operation corresponding to the gate line G1 and makes a display operation corresponding to the gate lines other than the gate line G1. The same operations go for other gate lines.

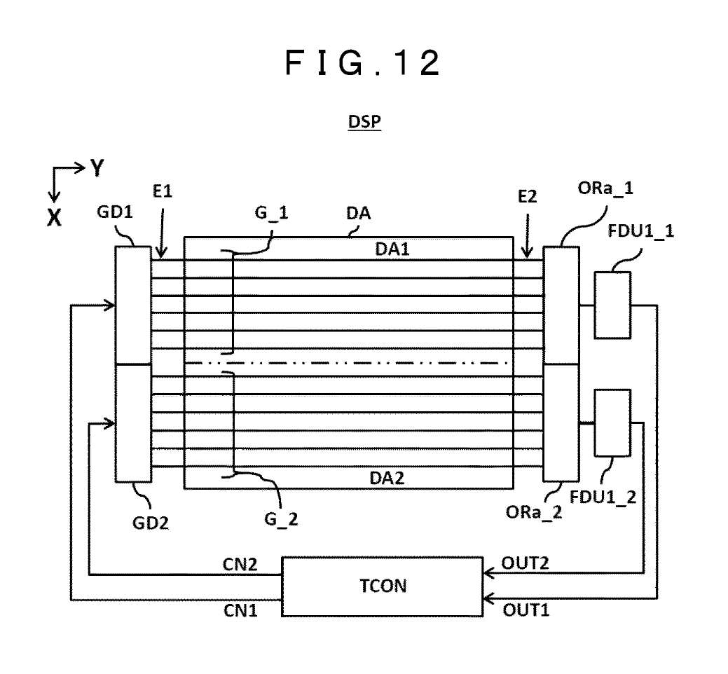

In another example, applied to FIG. 12, where drain electrodes of MOS transistors MT1 to MT6 are electrically connected to the line L11 and drain electrodes of MOS transistors MT7 to MTn are electrically connected to the line L12, the timing controller TCON, when having been notified of abnormality by the detection result L, stops a display operation using the second gate driver GD2 and makes a transition to a display operation using only the first gate driver GD1.

In further example, not shown in the diagram, odd-numbered gate lines may be electrically connected to the first gate driver GD1, and even-numbered gate lines may be electrically connected to the second gate driver GD2. In this case display stop operation may be configured described as above other examples.

In this way, in the display device DSP which is depicted in FIG. 9, it is enabled to stop the operation of one gate driver (GD1) driving a gate line detected as abnormal and make a transition to a display operation using the other gate driver (GD2).

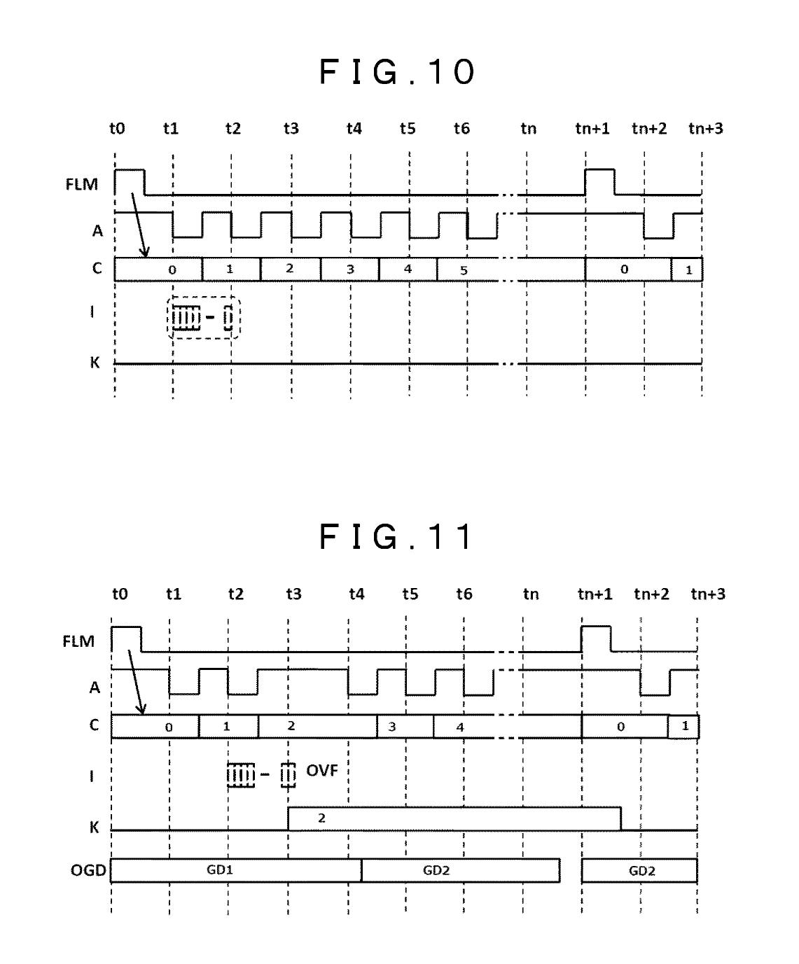

FIG. 10 is a timing diagram for explaining operation of the display device DSP in FIG. 9 when operating normally. FIG. 11 is a timing diagram for explaining operation of the display device DSP in FIG. 9 when encountering abnormality. In FIG. 10 and FIG. 11, the output A of the first OR circuit OR1, the output C of the first counter circuit COU1, the detection result I of the first frequency monitoring circuit FMON1, and the detection output K of the first location determining circuit LDET1 are depicted by way of example.

With reference to FIG. 10, operation of the display device DSP when operating normally is described.

At time t0, the frame sync signal FLM turns to a high level and the count value C of the first counter COU1 is initialized to zero. After that, the frame sync signal FLM transitions from the high level to a low level.

At time t1, a gate line G1 turns to a high level and then, turns to a low level. Accordingly, the output A of the first OR circuit OR1 turns from a high pre-charged level to a low level and then, turns to the high level. Therefore, the count value C of the first counter circuit COU1 becomes 1.

The first frequency monitoring circuit FMON1 counts the number of dot clocks DotCLK for a period between falling, at time t1, and falling, at time t2, of the output A of the first OR circuit OR1, thus measuring a cyclic period between falling edges of the output A of the first OR circuit OR1. The count value of the first frequency monitoring circuit FMON1 is reset at time t1 when the output A of the first OR circuit OR falls and the first frequency monitoring circuit FMON1 starts a measurement operation. Also, the count value of the first frequency monitoring circuit FMON1 is reset at time t2 when the output A of the first OR circuit OR falls and the first frequency monitoring circuit FMON1 starts a measurement operation.

For a time from time t2 to time tn, the output A of the first OR circuit OR1 likewise transitions between low and high levels sequentially and, therefore, the count value C of the first counter circuit COU1 will become 2, 3, 4 and up to N/2 sequentially. Meanwhile, the first frequency monitoring circuit FMON1 counts the number of dot clocks DotCLK for each of periods from time t2 to time t3, from time t3 to time t4, from time t4 to time t5, from time t5 to time t6, etc. Now, in FIG. 11, a measurement operation of the first frequency monitoring circuit FMON1 for a period from time t1 to time t2 is only depicted representatively to allow for simplification of the drawing. The detection result I of the first frequency monitoring circuit FMON1 is not generated, because there occurs no overflow OVF of the count value of the counter circuit within the first frequency monitoring circuit FMON1. The detection output K of the first location determining circuit LDET1 is kept at a level indicating that no abnormality occurs, e.g., like a low level.

With reference to FIG. 11, operation of the display device DSP in FIG. 9 when encountering abnormality is described. FIG. 11 is accompanied by OGD that denotes an operating gate driver.

In FIG. 11, for a period between time t3 and time t4, an abnormal state in which the output A of the first OR circuit OR1 does not transition to a low level and remains at a high level is indicated. In this case, the first frequency monitoring circuit FMON1 starts a measurement operation in sync with falling to the low level of the output signal A at time t2. But, because the output signal A does not transition to the low level at the point of time t3 and remains at the high level, the count value of the counter circuit within the first frequency monitoring circuit FMON1 is not reset to zero at time t3. Consequently, the count value of the first frequency monitoring circuit FMON1 becomes overflow OVF at a time past the time t3. Hence, the detection result I of the first frequency monitoring circuit FMON1 becomes a value indicating that overflow OVF has occurred corresponding to a gate line G3.

The first location determining circuit LDET1 takes in the count value (2) of the first counter circuit COU1 at the time of generation of the detection result I of the first frequency monitoring circuit FMON1 as the output C of the first counter circuit COU1 and outputs the output C as a detection result K (K=2) to the timing controller TCON. Based on input of the detection result K (K=2), the timing controller TCON determines that breaking of a gate line G3 has occurred or failure of a drive circuit for the gate line G3 in the first gate driver GD1 has occurred and performs control to stop the display operation of the first gate driver GD1 for next time displaying a frame.

Therefore, as indicated by OGD that denotes an operating gate driver, in a display operation at time tn+1 and subsequent, the display operation corresponding to the gate line G3 or the first gate driver GD is not used, and a display operation using the gate lines other than the gate line G3 or the second gate driver GD2 is performed.

In addition, although FIG. 9 gives an example in which two gate drivers, the first and second gate drivers, are provided, gate drivers may be provided, for example, for every six gate lines. By providing many gate drivers in this way, such a display device can be provided that enables it to perform a display operation for a wide display region using more gate lines, while making no display of only a narrow display region including a gate line detected as abnormal.

In addition, although, in FIG. 9, the first gate driver GD1 and the second gate driver GD2 are mounted to accommodate gate lines in each of divisions (e.g., upper and lower divisions) of the display area DA, the gate drivers may be configured to make the first gate driver GD1 accommodate one of two groups of odd-number positioned and even-number positioned gate lines and make the second gate driver GD2 accommodate the other of the two groups of odd-number positioned and even-number positioned gate lines. By thus configuring the gate drivers, it is enabled to display a screen as a whole even if stopping a display operation as a remedial action for a gate line detected as abnormal.

As another example, not shown in the diagram, the gate drivers may be configured to make the first gate driver GD1 accommodate one of two groups of an upper group and a lower group. The upper group includes gate lines G1 to G6 electrically connected to the first gate driver GD1, and the lower group includes gate lines G7 to GN electrically connected to the second gate driver GD2. In this case, not shown in the diagram, drain electrodes of the MOS transistors MT1 to MT6 are electrically connected to the line L11, and drain electrodes of the MOS transistors MT7 to MTn are electrically connected to the line L12.

In addition, although FIG. 9 gives an example in which two gate drivers, the first and second gate drivers, are provided, gate drivers may be provided, by providing a gate driver with a control function adapted to skip over a selection action of a unit drive circuit which drives a gate line determined as failed, control like that described hereinbefore can be implemented with one gate driver.

In addition, although, according to the foregoing description, the first frequency monitoring circuit FMON1 and the second frequency monitoring circuit FMON2 in FIG. 9 count the number of dot clocks DotCLK between one transition to low level and next transition to low level of the output A of the first OR circuit OR1 and the output B of the second OR circuit OR2, they may be altered to count the number of dot clocks DotCLK between one transition to high level and next transition to high level of the output A and the output B. In this case, it will be expedient to alter the first frequency monitoring circuit FMON1 so that the output A will be input via an inverter to it and alter the second frequency monitoring circuit FMON2 so that the output B will be input via an inverter to it.

FIG. 12 is a diagram for explaining another example of a configuration of the display device DSP pertaining to an embodiment of the invention. The display device DSP depicted in FIG. 12 is an example of modification to the display device DSP in FIG. 4. In FIG. 12, an OR circuit ORa and a detection unit FDU1 which are depicted in FIG. 4 are provided for each of display area divisions DA1 and DA2. By thus configuring the display device, it would become possible to determine a display area involving abnormality and present a partial display using a display are free of abnormality, avoiding use of the display area involving abnormality.

In FIG. 12, the display area DA is divided into a first display area DA1 and a second display area DA2. Along with this change, one end E1 of each gate line in a first group of gate lines G_1 provided in the first display area DA1 is electrically connected to a first gate driver GD1 and one end E1 of each gate line in a second group of gate lines G_2 provided in the second display area DA2 is electrically connected to a second gate driver GD2.

The other end E2 of each gate line included in the first group of gate lines G_1 is electrically connected to a first OR circuit ORa_1 and the first OR circuit ORa_1 is electrically connected to a first detection unit (or a first detection circuit) FDU1_1. The other end E2 of each gate line included in the second group of gate lines G_2 is electrically connected to a second OR circuit ORa_2 and the second OR circuit ORa_2 is electrically connected to a second detection unit (or a second detection circuit) FDU1_2.

Outputs OUT1 and OUT2 of the first and second detection units FDU1_1 and FDU1_2 are input to a timing control circuit TCON and the timing control circuit TCON outputs control signals CN1 and CN2 to the first and second drivers GD1 and GD2, respectively.

Each of the first and second OR circuits ORa_1 and ORa_2 is configured the same as the OR circuit ORa in FIG. 4 and each of the first and second detection units FDU1_1 and FDU1_2 is configured the same as the detection unit FDU1 in FIG. 4.

According to the configuration as above, the timing control circuit TCON, when the output OUT1 indicating abnormality has been input to it from the first detection unit FDU1_1, can send the first gate driver GD1 a control signal CN1 instructing it to stop operation. This enables a display operation using only the second gate driver GD2 for displaying a next frame. In addition, the timing control circuit TCON, when the output OUT2 indicating abnormality has been input to it from the second detection unit FDU1_2, can send the second gate driver GD2 a control signal CN2 instructing it to stop operation. This enables a display operating using only the first gate driver GD1 for displaying a next frame.

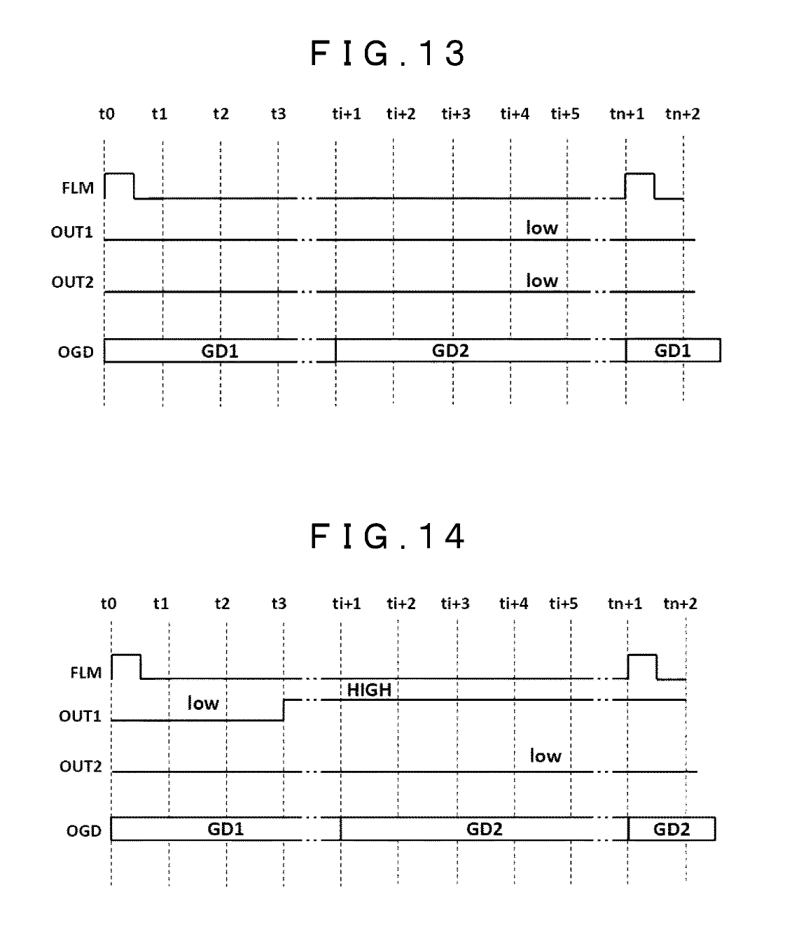

FIG. 13 is a timing diagram for explaining operation of the display device DSP in FIG. 12 when operating normally. The frame sync signal FLM transitions to a high level at time t0 and time tn+1 for activation. In addition, OGD that denotes an operating gate driver indicates that a display operation using the first gate driver is performed for a time from time t0, a display operation using the second gate driver GD2 is performed for a time from time ti+1, and an operation of displaying a next frame is performed for a time from time tn+1. Because normal operation that is free of failure is illustrated in FIG. 13, both the output OUT1 of the first detection unit FDU1_1 and the output OUT2 of the second detection unit FDU1_2 are kept at a low level which indicates a failure-free state.

FIG. 14 is a timing diagram for explaining operation of the display device DSP in FIG. 12 when encountering abnormality. The difference between FIG. 13 and FIG. 14 lies in that, at time t3, the output OUT1 of the first detection unit FDU1_1 changes to a high level which indicates abnormality occurring. That is, it indicates that it has been detected that failure is present in a gate line or the first gate driver in the first display area DA1. Therefore, in an operation of displaying a next frame, which starts from time tn+1, the first gate driver GD1 is placed in a stop state by the control signal CN1 from the timing control circuit TCON and a transition is made to a display operation using the second gate driver GD2 for display only in the second display area DA2.

As per the configuration depicted in FIGS. 12 to 14, the timing control circuit TCON, when the output OUT1 indicating abnormality has been input to it from the first detection unit FDU1_1, can send the first gate driver GD1 a control signal CN1 instructing it to stop operation. This enables a display operation using only the second gate driver GD2 for displaying a next frame. In addition, the timing control circuit TCON, when the output OUT2 indicating abnormality has been input to it from the second detection unit FDU1_2, can send the second gate driver GD2 a control signal CN2 instructing it to stop operation. This enables a display operating using only the first gate driver GD1 for displaying a next frame.

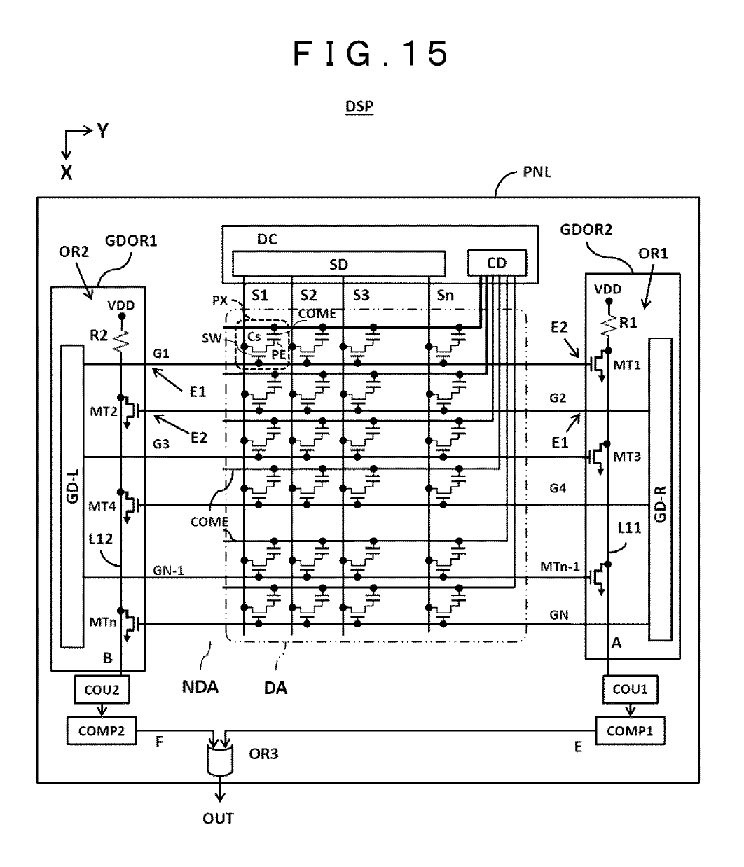

FIG. 15 is a diagram for explaining yet another example of a configuration of the display device DSP pertaining to an embodiment of the invention. FIG. 15 is an example of modification to FIG. 4 and the gate driver GD in FIG. 4 is separated into two units on left and right sides of the display area DA and the units are placed as a left gate driver GD-L and a right gate driver GD-R. On the other hand, to the left gate driver GD-L, one ends E1 of odd-number positioned gate lines G1, G3, . . . , GN−1 are electrically connected. To the right gate driver GD-R, one ends E1 of even-number positioned gate lines G2, G4, . . . , GN are electrically connected.

To the other ends E2 of the odd-number positioned gate lines G1, G3, . . . , GN−1, inputs of a first OR circuit OR1 are electrically connected. The first OR circuit OR1 is configured the same as the first OR circuit OR1 in FIG. 4 and, therefore, its description is omitted. In addition, to the other ends E2 of the even-number positioned gate lines G2, G4, . . . , GN, inputs of a second OR circuit OR2 are electrically connected. The second OR circuit OR2 is configured the same as the second OR circuit OR2 in FIG. 4 and, therefore, its description is omitted.

Output A of the first OR circuit OR2 is electrically connected to a first counter COU1 and output of the first counter COU is electrically connected to a first comparator circuit COMP1. In addition, output B of the second OR circuit OR 2 is electrically connected to a second counter COU2 and output of the second counter COU2 is electrically connected to a second comparator circuit COMP2. Output E of the first comparator circuit COMP1 and output F of the second comparator circuit COMP2 are electrically connected to input of a third OR circuit OR3 and an output signal OUT is output from the output of the third OR circuit OR3.

In this way, it is possible to make a configuration in which the second OR circuit OR2 is integrated in the left gate driver GD-L. It is also possible to make a configuration in which the first OR circuit OR1 is integrated in the right gate driver GD-R. In other words, the left gate driver GD-L and the second OR circuit OR2 can be regarded as a left gate driver GDOR1. Also, the right gate driver GD-R and the first OR circuit OR1 can be regarded as a right gate driver GDOR2.

The first counter circuit COU1 and the first comparator circuit COMP1 may be integrated in and formed within the left gate driver GDOR1. Also, the second counter circuit COU2 and the second comparator circuit COMP2 may be integrated in and formed within the right gate driver GDOR2. The third OR circuit OR3 may be integrated in either of the left gate driver GDOU1 and the right gate driver GDOR2. Additionally, it is also possible to provide the first counter circuit COU1, the first comparator circuit COMP1, the second counter circuit COU2, the second comparator circuit COMP2, and the third OR circuit OR3 within the drive IC chip IC or the control module CM which are depicted in FIG. 2.

Even also in FIG. 15, it is possible to stop a gate driver circuit which accommodates a gate line in which failure has occurred and a display operation, using a detection unit FDU2 having a failure location determining function like that depicted in FIG. 9.

Although the OR circuit is configured with N-type MOS transistors as described previously as an embodiment of the present invention, it is possible to configure the OR circuit using P-type MOS transistors in such a way in which the sources of the P-type MOS transistors are electrically connected to a high potential power supply, a resistor is electrically connected between their drains and a low potential power supply, and the drains form the output of the OR circuit. It is also possible to make other configurations of the OR circuit.

Based on the display device described hereinbefore as an embodiment of the present invention, those skilled in the art might change its design, as appropriate, to construct a display device. All display devices that can be obtained in this way should fall within the scope of the present invention, as long as containing the spirit of the present invention. In addition to a liquid crystal display device, e.g., an organic EL (OLED) display device and other display devices should fall within the scope of the present invention.

Within the scope of the concept of the present invention, various changes and modifications may occur to those skilled in the art and such changes and modifications should be understood to fall within the scope of the present invention. Any of the embodiments described hereinbefore modified by those skilled in the art, e.g., by adding a component to an embodiment, removing a component from an embodiment, or changing its design, or adding/deleting a step, or altering a condition, should be included in the scope of the present invention, as long as entailing the spirit of the present invention.

As for other beneficial effects that are offered by aspects described in the embodiments of the invention, those that are obvious from the description herein and those that may occur to those skilled in the art should, of course, be understood to be offered by the present invention.

It is possible to create variants of the invention by appropriately combining plural components which are disclosed in the foregoing embodiments. For example, some components may be removed from all components that are described in an embodiment. Furthermore, components across different embodiments may be combined, as appropriate.

What is claimed is:

1. A display device comprising:
a display area;
a peripheral area surrounding the display area;
a plurality of gate lines extending in a first direction in the display area and connected to a plurality of TFTs;
a gate line driving circuit provided in the peripheral area and connected with one ends of the gate lines;
an OR circuit provided in the peripheral area and having inputs connected with the other ends of the gate lines; and
a counter provided in the peripheral area and to which output of the OR circuit is connected.

2. The display device according to claim 1, comprising a comparator circuit,
wherein the comparator circuit compares the number of times counted by the counter with a predetermined number of times and outputs an abnormality detection signal when the number of times counted does not match the predetermined number of times.

3. The display device according to claim 1, wherein the OR circuit includes an open drain wired OR circuit.

4. The display device according to claim 3, further comprising a period measurement circuit and an abnormality location determining circuit,
wherein the abnormality location determining circuit determines the position of a gate line in which abnormality has occurred, based on the number of times counted by the counter and a decision value of the period measurement circuit.

5. The display device according to claim 1, wherein the gate line driving circuits are placed in the peripheral area and on either side of the display area across the display area.

6. The display device according to claim 2, wherein after output of the abnormality detection signal, power supply of the display device is interrupted.

7. The display device according to claim 6, wherein after a predetermined interval of time after the power supply of the display device is interrupted, the power supply of the display device is recovered.

8. The display device according to claim 7, wherein, when the number of times that the abnormality detection signal has been output has reached a predetermined number of times, the display device performs at least one of processing tasks as follows: always interrupting the power supply, turning on a warning lamp, and storing failure information.

9. The display device according to claim 1,
wherein the gate line driving circuit is separated into a plurality of groups, and
wherein the OR circuit and the counter are provided for each of the groups and make an abnormality decision.
